(19) United States
(12) Patent Application Publication
(10) Pub. No.: US 2025/0172019 A1
(43) Pub. Date: May 29, 2025

(54) BRACKET MEMBER FOR A VEHICLE LOCK HOUSING ASSEMBLY

(71) Applicant: NISSAN NORTH AMERICA, INC., Franklin, TN (US)

(72) Inventors: David KOVIE, Livonia, MI (US); James HAUPT, Livonia, MI (US)

(21) Appl. No.: 18/521,487

(22) Filed: Nov. 28, 2023

(51) Int. Cl. E05B 79/04; E05B 85/02

(52) U.S. Cl. CPC E05B 79/04; E05B 85/02

(57) ABSTRACT

A bracket member for a lock housing assembly of a vehicle includes a base member. A first wall extends outwardly form the base member. The first wall is configured to contact a first wall of a lock housing of the lock housing assembly. A second wall extends outwardly from the base member. The second wall is configured to contact a second wall of the lock housing assembly. A curved portion is connected to the base member. The curved portion is configured to support a lock lever of the lock housing assembly.

### BACKGROUND

### Technical Field

The present disclosure generally relates to a bracket member for a vehicle lock housing assembly. More specifically, the present disclosure relates to bracket member that substantially prevents deflection of a lock lever of a vehicle lock housing assembly.

### Background Information

A lock lever transmits rotation of a key in a key cylinder to a lock housing to lock and unlock a vehicle door. The lock lever can deflect during operation of the key resulting in ineffective locking and unlocking operations.

### SUMMARY

An object of the present disclosure is to provide a bracket member for a vehicle lock housing assembly.

In view of the state of the known technology, one aspect of the present disclosure is to provide a bracket member for a lock housing assembly of a vehicle. The bracket member includes a base member. A first wall extends outwardly form the base member. The first wall is configured to contact a first wall of a lock housing of the lock housing assembly. A second wall extends outwardly from the base member. The second wall is configured to contact a second wall of the lock housing assembly. A curved portion is connected to the base member. The curved portion is configured to support a lock lever of the lock housing assembly.

Another aspect of the present disclosure is to provide a lock housing assembly for a vehicle. The lock housing assembly includes a lock housing, a lock lever, and a bracket member. The lock lever is rotatably connected to the lock housing. The bracket member is connected to the lock housing and rotatably supports the lock lever.

Also other objects, features, aspects and advantages of the disclosed bracket member for a vehicle lock housing assembly will become apparent to those skilled in the art from the following detailed description, which, taken in conjunction with the annexed drawings, discloses exemplary embodiments of the bracket member for a vehicle lock housing assembly.

### BRIEF DESCRIPTION OF THE DRAWINGS

Referring now to the attached drawings which form a part of this original disclosure:

FIG. 1 is a perspective view of a keyway in a door handle of a vehicle;

FIG. 2 is a perspective view of a lock lever of a lock housing prior to installation of a bracket member;

FIG. 3 is a lower perspective view of a bracket member supporting the lock lever of FIG. 2;

FIG. 4 is a side perspective view of the bracket member supporting the lock lever of FIG. 2 with a rod removed for clarity;

FIG. 5 is a perspective view of the bracket member of FIGS. 3 and 4; and

FIG. 6 is a side elevational view of the bracket member supporting the lock lever, in which other components are removed for clarity.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

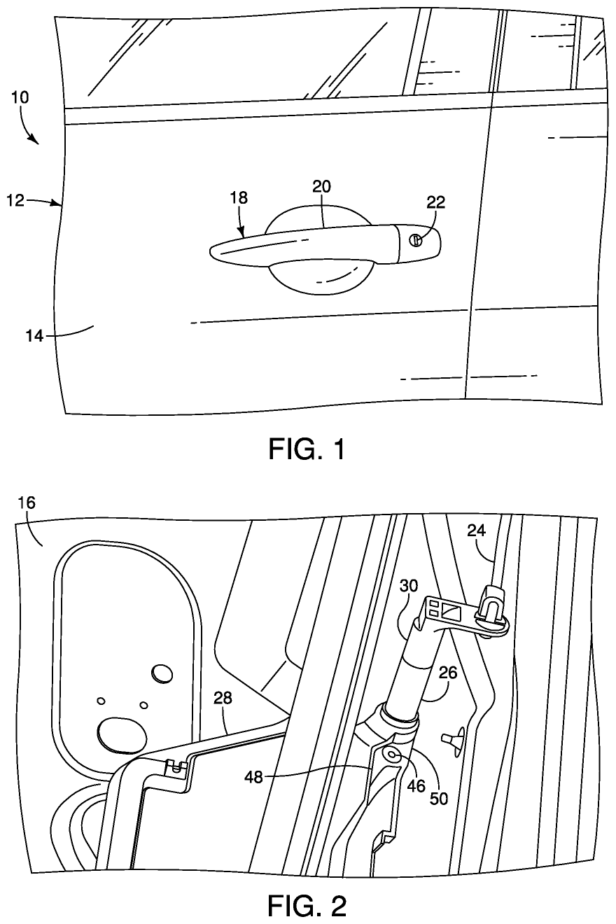

Referring initially to FIG. 1, a vehicle 10 includes a vehicle door 12. The vehicle door 12 includes an outer door panel 14 and an inner door panel 16, as shown in FIGS. 1 and 2. The outer door panel 14 includes a door handle assembly 18, as shown in FIG. 1. The door handle assembly 18 includes a door handle 20 that is manually operated to open and close the door 12.

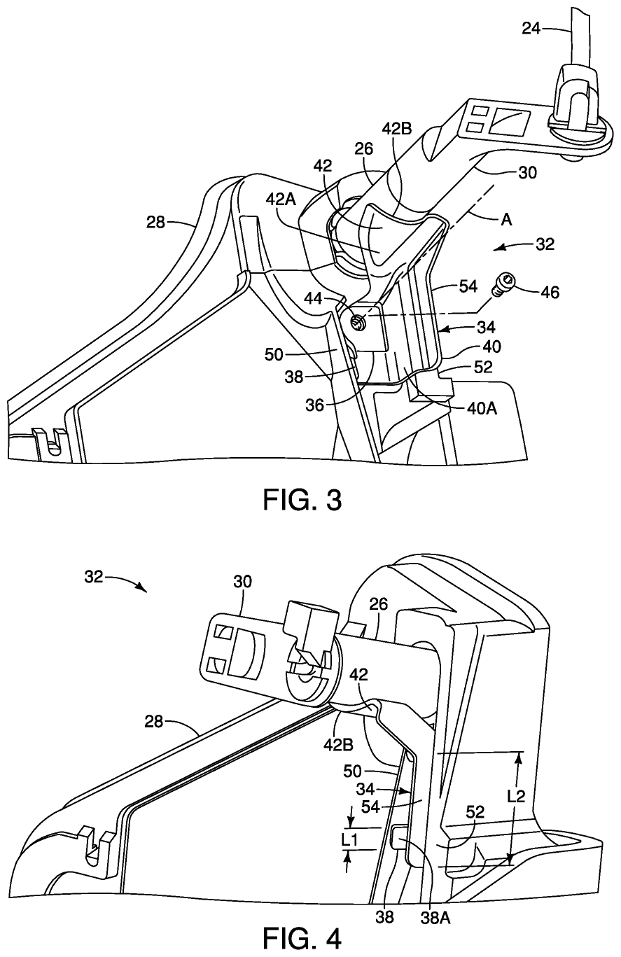

A keyway 22 is disposed in the door handle 20 of the door handle assembly 18, as shown in FIG. 1. The keyway 22 is configured to receive a vehicle key to manually lock and unlock the vehicle door 12. A key cylinder (not shown) is aligned with the keyway 22 and disposed on a vehicle inboard side of the outer door panel 14. A rod 24 extends from the key cylinder to a lock lever 26, as shown in FIGS. 2 and 3. The lock lever 26 is rotatably connected to a lock housing 28 by a connecting member 30. Inserting the key in the keyway 22 and rotating the key rotates the key cylinder. The rotation of the key cylinder is transmitted to the rod 24. Movement of the rod 24 is transmitted to the lock lever 26 by the connecting member 30. The connecting member 30 transmits the movement of the rod 24 to rotational movement of the lock lever 26. Rotation of the lock lever 26 moves the lock (not shown) between locked and unlocked positions. Upward movement of the rod 24 rotates the lock lever 26 in a counter-clockwise direction resulting in an unlocking operation. Downward movement of the rod 24 causes clockwise rotation of the lock lever resulting in a locking operation.

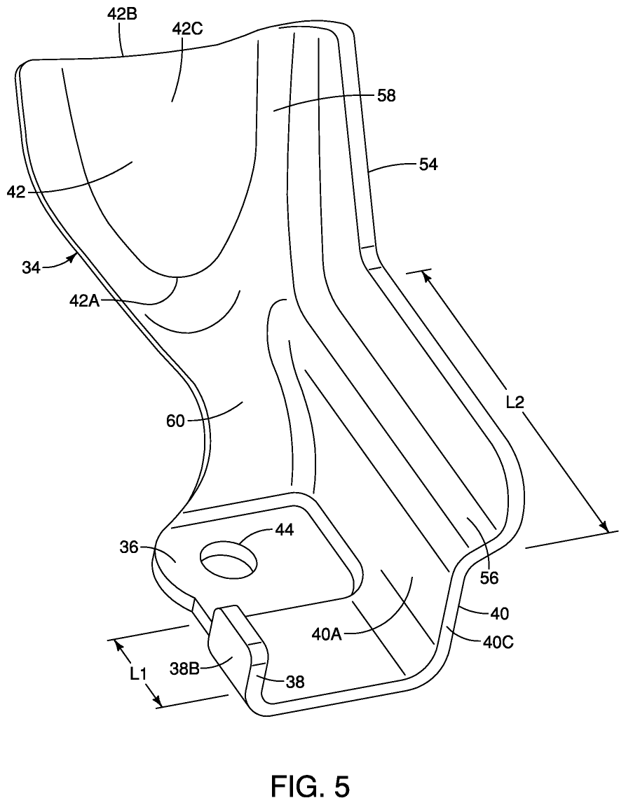

A lock housing assembly 32 includes the lock housing 28, the lock lever 26, and a bracket member 34, as shown in FIGS. 3 and 4. The lock lever 26 is rotatably connected to the lock housing 28. The bracket member 34 is connected to the lock housing 28, as shown in FIGS. 3 and 4, and rotatably supports the lock lever 26.

The bracket member 34 includes a base member 36, as shown in FIGS. 3 and 5. A first wall 38 extends outwardly from the base member 36. A second wall 40 extends outwardly from the base member 36. A curved portion 42 is connected to the base member 36. The bracket member 34 is made of a metallic material, such as a stainless steel. The bracket member 34 is preferably unitarily formed as a one-piece member.

A fastener opening 44 is disposed in the base member 36, as shown in FIGS. 3 and 5. The fastener opening 44 is configured to receive a fastener 46 to secure the bracket member 34 to the lock housing 28 of the lock housing assembly 32. As shown in FIG. 2, the lock housing 28 includes a fastener opening 48. In the installed position, as shown in FIG. 3, the fastener opening 44 in the bracket member 34 is aligned with the fastener opening 48 in the lock housing 28. The fastener 46 is inserted through the fastener opening 44 in the bracket member 34 and through the fastener opening 46 in the lock housing 28 to secure the bracket member 34 to the lock housing 28 of the lock housing assembly 32.

The first wall 38 extends outwardly from the base member 36 of the bracket member 34, as shown in FIG. 5. The first wall 38 preferably extends substantially perpendicularly from the base member 36. The first wall 38 has an inner surface 38A and an outer surface 38B, as shown in FIGS. 4 and 5. The inner surface 38A of the first wall 38 faces the second wall 40. The first wall 38 has a first length L1.

The second wall 40 extends outwardly from the base member 36 of the bracket member 34, as shown in FIG. 5. The second wall 40 preferably extends substantially perpendicularly from the base member 36. The second wall 40 has an inner surface 40A and an outer surface 40B. The inner surface 40A of the second wall 40 faces the first wall 38, as shown in FIGS. 3 and 5. The inner surface 40A of the second wall 40 faces the inner surface 38A of the first wall 38. The second wall 40 is preferably substantially parallel to the first wall 38. The fastener opening 44 is disposed between the first wall 38 and the second wall 40 of the bracket member 34 when viewed in a direction parallel to a longitudinal axis A of the fastener opening 44. The first length L1 of the first wall 38 is less than a second length L2 of the second wall 40.

The lock housing 28 includes a first wall 50 and a second wall 52, as shown in FIGS. 2-5. The first wall 38 of the bracket member 34 is configured to contact the first wall 50 of the lock housing 28 of the lock housing assembly 32 when the bracket member 34 is secured to the lock housing 28. The outer surface 38B of the first wall 38 of the bracket member 34 contacts the first wall 50 of the lock housing 28.

The second wall 40 of the bracket member 34 is configured to contact the second wall 52 of the lock housing 28 of the lock housing assembly 32 when the bracket member 34 is secured to the lock housing 28, as shown in FIGS. 3-5. The outer surface 40B of the second wall 40 of the bracket member 34 contacts the second wall 52 of the lock housing 28.

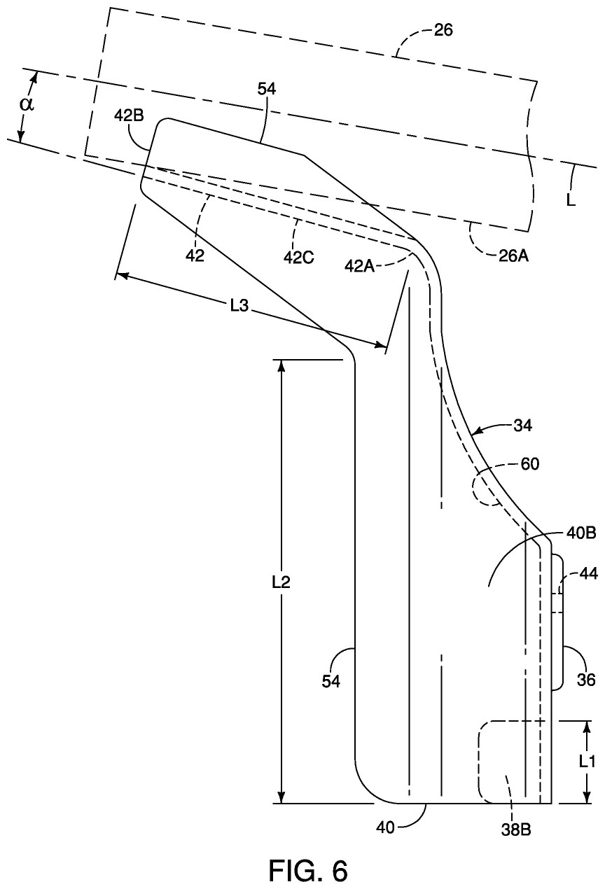

The curved portion 42 of the bracket member 34 is configured to support the lock lever 26 of the lock housing assembly 32, as shown in FIGS. 3-6. The curved portion 42 extends outwardly from the base member 36. The curved portion 42 has a first end 42A and a second end 42B. The first end 42A of the curved portion 42 is nearer the base member 36 than the second end 42B. The first end 42A is nearer the lock housing 28, as shown in FIGS. 3 and 4. The curved portion 42 tapers downwardly from the second end 42B toward the first end 42A, as shown in FIG. 6. The curved portion 42 tapers away from the lock lever 26 from the second end 42B toward the first end 42A. In other words, an angle α is formed between a longitudinal axis L of the lock lever 26 and a lower surface 42C of the curved portion 42. The angle α is a non-zero angle to minimize contact of the curved portion 42 of the bracket member 34 to the lock lever 26 to minimize rotational friction therebetween. The second end 42B of the curved portion 42 contacts the lock lever 26. The first end 42A of the curved portion 42 is spaced from the lock lever 26. In other words, the second end 42B of the curved portion 42 contacts the lowermost surface 26A of the lock lever 26, and the first end 42A of the curved portion 42 is spaced from the lowermost surface 26A of the lock lever 26. The curved portion 42 has a length L3 from the first end 42A to the second end 42B. A length of the curved portion 42 contacting the lowermost surface 26A of the lock lever 26 is less than L3. A distance between the curved portion 42 and the first end 42A of the curved portion 42 increases from the second end 42B toward the first end 42A. The second end 42B of the curved portion 42 substantially surrounds a portion of the circumference of the lock lever 26 when viewed in a direction substantially parallel to the longitudinal axis L of the lock lever 26 to prevent the lock lever 26 from moving over either wall forming the curved portion 42 during locking and unlocking operations.

A third wall 54 extends from a first end 40C of the second wall 40 to the second end 42B of the curved portion 42, as shown in FIGS. 3-5. A first connecting portion 56 of the bracket member 34 connects the third wall 54 to the second wall 40. The third wall 54 is preferably substantially parallel to the second wall 40. A second connecting portion 58 of the bracket member 34 connect the third wall 54 to the curved portion 42. A third connecting portion 60 of the bracket member 34 connects the curved portion 42 to the base member 36 and to the second wall 40.

In the installed position, as shown in FIGS. 3 and 4, the first wall 38 of the bracket member 34 is disposed adjacent the first wall 50 of the lock housing 28 and the second wall 40 of the bracket member 34 is disposed adjacent the second wall 52 of the lock housing 28. The curved portion 42 supports rotation of the lock lever 26 during locking and unlocking operation. The first and second walls 38 and 40 of the bracket member 34 contact the first and second walls 50 and 52 of the lock housing 28 to substantially prevent movement of the bracket member 34 during rotational movement of the lock lever 26. The curved portion 42 of the bracket member 34 supports rotational movement of the lock lever 26 during locking and unlocking operations to substantially prevent deflection of the lock lever 26. The bracket member 34 further substantially prevents deflection of the lock lever 26 due to build tolerances and variations and temperature influences.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the bracket member for a vehicle lock housing assembly. Accordingly, these terms, as utilized to describe the present invention should be interpreted relative to a vehicle equipped with the bracket member for a vehicle lock housing assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bracket member for a lock housing assembly of a vehicle, the bracket member comprising:
a base member;
a first wall extending outwardly form the base member, the first wall being configured to contact a first wall of a lock housing of a lock housing assembly;
a second wall extending outwardly from the base member, the second wall being configured to contact a second wall of the lock housing assembly; and
a curved portion connected to the base member, the curved portion being configured to support a lock lever of the lock housing assembly.

2. The bracket member according to claim 1, wherein
a fastener opening is disposed in the base member, the fastener opening being configured to receive a fastener to secure the bracket member to a lock housing of the lock housing assembly.

3. The bracket member according to claim 1, wherein
the fastener opening is disposed between the first wall and the second wall of the bracket member when viewed in a direction parallel to a longitudinal axis of the fastener opening.

4. The bracket member according to claim 1, wherein
the first wall is substantially parallel to the second wall.

5. The bracket member according to claim 1, wherein
the first wall has a first length less than a second length of the second wall.

6. The bracket member according to claim 1, wherein
the curved portion has a first end and a second end, the first end being nearer the base member.

7. The bracket member according to claim 6, wherein
the curved portion tapers downwardly from the second end toward the first end.

8. The bracket member according to claim 1, wherein
the bracket member is made of steel.

9. The bracket member according to claim 1, wherein
the bracket member is unitarily formed as a one-piece member.

10. A lock housing assembly for a vehicle comprising:
a lock housing;
a lock lever rotatably connected to the lock housing; and
a bracket member connected to the lock housing and rotatably supporting the lock lever.

11. The lock housing assembly according to claim 10, wherein
a first wall of the bracket member contacts the lock housing to substantially prevent movement of the bracket member.

12. The lock housing assembly according to claim 11, wherein
a second wall of the bracket member contacts the lock housing to substantially prevent movement of the bracket member.

13. The lock housing assembly according to claim 12, wherein
the first wall is substantially parallel to the second wall.

14. The lock housing assembly according to claim 13, wherein
a fastener opening in the bracket member is configured to receive a fastener to secure the bracket member to the lock housing.

15. The lock housing assembly according to claim 14, wherein
the fastener opening is disposed between the first wall and the second wall of the bracket member when viewed in a direction parallel to a longitudinal axis of the fastener opening.

16. The lock housing assembly according to claim 10, wherein
a curved portion of the bracket member receives the lock lever.

17. The lock housing assembly according to claim 16, wherein
the curved portion has a first end and a second end, the first end being nearer the lock housing.

18. The lock housing assembly according to claim 17, wherein
the curved portion tapers away from the lock lever from the second end to the first end.

19. The lock housing assembly according to claim 17, wherein
the second end of the curved portion contacts the lock lever, and the first end of the curved portion is spaced from the lock lever.

20. The lock housing assembly according to claim 10, wherein
the bracket member is unitarily formed as a one-piece member.
